(19) United States
(12) Patent Application Publication
(10) Pub. No.: US 2016/0232451 A1
(43) Pub. Date: Aug. 11, 2016

(54) SYSTEMS AND METHODS FOR MANAGING AUDIO CONTENT

(71) Applicant: Shimon B. SCHERZER, Korazim (IL)

(72) Inventor: Shimon B. SCHERZER, Korazim (IL)

(73) Assignee: VELOCEE LTD., Rishon LeTsiyon (IL)

(21) Appl. No.: 14/799,173

(22) Filed: Jul. 14, 2015

Related U.S. Application Data
(60) Provisional application No. 62/113,715, filed on Feb. 9, 2015.
(60) Provisional application No. 62/148,610, filed on Apr. 16, 2015.

(51) Int. Cl. G06N 5/04; G06F 17/30; H04L 29/08; H04W 88/02

(52) U.S. Cl. CPC G06N 5/04; H04W 88/02; G06F 17/30772; H04L 67/2847

(57) ABSTRACT

Systems and methods are disclosed for managing pre-cached audio content. In one implementation, a method may include acquiring information reflecting browsing history of a user associated with a mobile device. The method may further include predicting a plurality of media items associated with audio content that the user is likely to listen in a screenless state based on the information reflecting browsing history. The method may also include organizing a playlist from the audio content associated with the plurality of predicted media items, and pre-caching the playlist in a memory device of the mobile device. The method may further include receiving input from the user regarding the playlist, wherein the input may be communicated using an eyes-free device associated with the mobile device.

### CROSS REFERENCES TO RELATED APPLICATIONS

This application claims the benefit of priority of U.S. Provisional Patent Application No. 62/113,715, filed on Feb. 9, 2015 and U.S. Provisional Patent Application 62/148,610 filed on Apr. 16, 2015. Both Applications are incorporated herein by reference in their entirety.

### TECHNICAL FIELD

This disclosure generally relates to systems and methods for managing audio content and, more particularly, to systems and methods for managing pre-cached audio content.

### BACKGROUND

Predication systems have become very common with the growth of internet-based streaming services such as Pandora and Netflix. These systems try to predict media items that users may have an interest in by using machine learning algorithms and information about users' preferences, for example, preferred songs and artists. With these known services, however, explicit information and feedback from the users is required for the algorithms to accurately predict additional media items.

While these internet-based services may work in some cases, they fall short in predicting media items when users do not provide enough feedback regarding their preferences. Additionally, in the mobile environment, applications of these services become virtually useless when the display of the mobile devices become inaccessible. For example, while driving or hiking, using mobile devices is inherently dangerous for obvious reasons. Also a different application, such as a navigation application, may populate the display of the mobile devices, which interferes with how users interact with the application.

One possible implementation of a predication system is described in Applicant's co-pending U.S. Patent Application Publication No. 2010/0161831 (the '831 publication), which is incorporated herein by reference. The '831 publication describes a system for accelerating browsing by pre-caching in the mobile device content predicated to be consumed by users.

There is a need for a system that does not depend on feedback regarding the content it provides to accurately predict additional media items. Also, the usage of this system should enable the user to consume audio content associated with the predicted media items when the mobile device's display becomes inaccessible for content search and identification. The systems and methods of the present disclosure are directed towards overcoming one or more of the problems as set forth above.

### SUMMARY

In one aspect, the present disclosure is directed to a method for managing pre-cached audio content. The method may include acquiring information reflecting browsing history of a user associated with at least one mobile device. The method may further include predicting a plurality of media items associated with audio content that the user is likely to listen in a screenless state based on the information reflecting browsing history. A screenless state occurs when a display of the at least one mobile device is set not to display visual presentation related to the plurality of media items. The method may also include organizing a playlist from the audio content associated with the plurality of predicted media items, and pre-caching the playlist in a memory device of the at least one mobile device. In addition, the method may include receiving feedback from the user regarding the playlist, wherein the feedback is communicated using an eyes-free device associated with the at least one mobile device.

In another aspect, the present disclosure is directed to a server for delivering audio content. The server may include at least one processing device and a memory device configured to store information regarding a plurality of users, each user may be associated with at least one mobile device. The at least one processing device may be configured to receive information reflecting browsing history of the plurality of users, and to identify a plurality of groups of users based on the information reflecting browsing history. Each group of users may be associated with a group profile. The at least one processing device may also be configured to predict, for each group of users, a plurality of media items associated with audio content that members of the group of users are likely to listen in a screenless state based on the group profile, wherein the screenless state occurs when a display of the mobile device is set not to display visual presentation related to the plurality of media items. The at least one processing device may further be configured to organize, for each group of users, a playlist from the audio content associated with the plurality of predicted media items. In addition, the at least one processing device may further be configured to manage delivery of different playlists to the plurality of users.

In yet another aspect, the present disclosure is directed to a non-transitory computer-readable medium having executable instructions stored thereon for a mobile device having at least one processing device, a memory device and a display. The instructions, when executed by the at least one processing device, cause the mobile device to complete a method for managing pre-cached audio content. The method includes transmitting to a server information reflecting browsing history of a user associated with the mobile device, and receiving from the server a playlist of audio content associated with a plurality of media items predicted by the server based on the information reflecting browsing history. The method further includes storing the audio content in the memory device before the mobile device enters a screenless state, wherein the screenless state occurs when the screen is set not to display visual presentation related to the plurality of media items. Upon identifying that the mobile device has entered a screenless state, the method includes initiating an audible presentation of the playlist, and receiving feedback regarding the playlist from an eyes-free device associated with the mobile device. The method further includes managing the playlist based on the feedback.

### BRIEF DESCRIPTION OF THE DRAWINGS

The accompanying drawings, which are incorporated in and constitute a part of this disclosure, illustrate various disclosed embodiments. In the drawings:

FIG. 1 is a diagrammatic representation illustrating the data flow between a server and a plurality of mobile devices consistent with a disclosed embodiment;

FIG. 2 is a block diagram illustrating the components of an exemplary mobile device that may be used in conjunction with the embodiment of FIG. 1;

FIG. 3 is a flow chart illustrating an exemplary process that may be performed by the server or mobile devices of FIG. 1 consistent with disclosed embodiments;

FIG. 4 is a diagrammatic representation illustrating a situation in which system and methods of this disclosure may be employed;

FIG. 5 is a flow chart illustrating an exemplary process that may be performed by the mobile device of FIG. 2 consistent with disclosed embodiments;

FIG. 6 is a flow chart illustrating an exemplary process that may be performed by the server of FIG. 1 consistent with disclosed embodiments; and

FIG. 7 is a diagrammatic representation of a usage matrix and a rating matrix in accordance with disclosed embodiments.

### DETAILED DESCRIPTION

The following detailed description refers to the accompanying drawings. Wherever possible, the same reference numbers are used in the drawings and the following description to refer to the same or similar parts. While several illustrative embodiments are described herein, modifications, adaptations and other implementations are possible. For example, substitutions, additions or modifications may be made to the components illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope is defined by the appended claims.

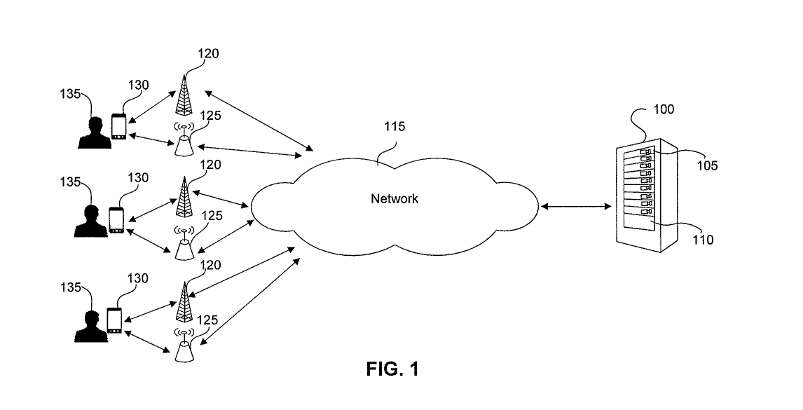

Disclosed embodiments provide systems and methods for delivery and managing media content. FIG. 1 is a diagrammatic representation illustrating the data flow between a server 100 and a plurality of mobile devices 130 consistent with a disclosed embodiment. Server 100 may use a memory device 105 and a processing device 110 to predict media items and organize a playlist, such that a personalized playlist may be transmitted to at least one mobile device 130 associated with user 135. The playlist may be transmitted using network 115 and either by a cellular network 120 or by a wireless local area network 125.

In some embodiments server 100 may deliver media content to the plurality of users 135. The term “server” refers to a device connected to a communication network having storing and processing capabilities. One example of server 100 is a dedicated Internet server hosting a web site associated with the media content being delivered. Another example of server 100 is a PC associated with one of the plurality of users 135 and connected to the Internet. In some embodiments, server 100 may aggregate information from users 135, and predict one or more media items that users 135 may be interested in. The media items may have any type of format, genre, duration, and classification. For example, the media items may include video items (e.g., movies and sports broadcasts), audio items (e.g., songs and radio broadcasts), and textual items (e.g., articles, news, books, etc.). One skilled in the art will appreciate that the textual items may be associated with an audio content. For example, a newspaper article may be associated with audio content that narrates the article.

Memory device 105 is configured to store information regarding users 135. The term “memory device” may include any suitable storage medium for storing digital data or program code. For example, RAM, ROM, flash memory, a hard drive, etc. The information collected from the plurality of users 135 may include information reflecting the user content consuming habits, for example, the time of day user 135 consumes media content. The information collected from the plurality of users 135 may also include information reflecting the browsing history of the plurality of users 135. In one embodiment, the information reflecting browsing history may include details about previous interests of users 135 in various websites. In addition, memory device 105 may store different media items that users 135 may be interested in or audio content associated with the media items that users 135 may be interested in.

Processing device 110 is in communication with memory device 105. The term “processing device” may include any physical device having an electric circuit that performs a logic operation on input. For example, the processing device 110 may include one or more integrated circuits, microchips, microcontrollers, microprocessors, all or part of a central processing unit (CPU), graphics processing unit (GPU), digital signal processor (DSP), field programmable gate array (FPGA), or other circuits suitable for executing instructions or performing logic operations. In some embodiments, processing device 110 may be associated with a software product stored on a non-transitory computer readable medium (e.g., memory device 105) and comprising data and computer implementable instructions. The instructions, when executed by processing device 110, cause server 100 to perform operations. For example, one operations may cause server 100 to predict a plurality of media items associated with audio content that user 135 is likely to listen.

In some embodiments, server 100 may communicate with a plurality of mobile devices 130 using network 115. Network 115 may be a shared, public, or private network, it may encompass a wide area or local area, and may be implemented through any suitable combination of wired and/or wireless communication networks. Network 115 may further include an intranet or the Internet, and the components in network 115 may access legacy systems (not shown). The communication between server 100 and mobile devices 130 may be accomplished directly via network 115 (e.g., using a wired connection) or through cellular network 120 or through wireless local area network 125. Alternatively, the communication between server 100 and mobile devices 130 may be accomplished through any suitable communication channels, such as, for example, a telephone network, an extranet, an intranet, the Internet, satellite communications, off-line communications, wireless communications, transponder communications, a local area network (LAN), a wide area network (WAN), and a virtual private network (VPN).

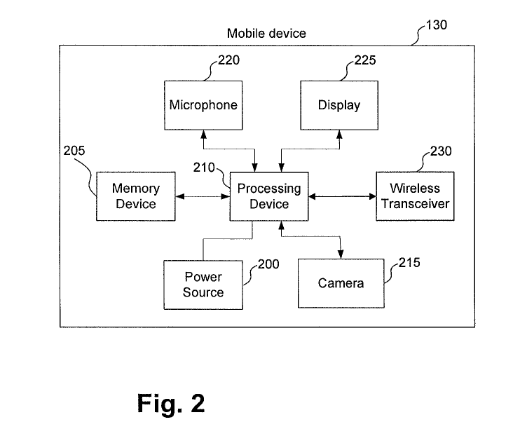

FIG. 2 is a block diagram illustrating the components of an exemplary mobile device 130. The term “mobile device” as used herein refers to any device configured to communicate with a wireless network, including, but not limited to a smartphone, smartwatch, tablet, mobile station, user equipment (UE), personal digital assistant, laptop, e-Readers, a connected vehicle, and any other device that enables wireless data communication. As shown in FIG. 2, mobile device 130 may include a power source 200, a memory device 205, a processing device 210, a camera 215, a microphone 220, a display 225, and a wireless transceiver 230. One skilled in the art, however, will appreciate that the configuration of mobile device 130 may have numerous variations and modifications. Some mobile devices 130 may include additional components (e.g., GPS, accelerometers, and various sensors), while other mobile devices 130 may include fewer components. The components shown in FIG. 2, and further being discussed below, should not be considered as essential for the operation of mobile device 130.

In some embodiments, a mobile device 130 may be associated with a software product (e.g., an application) stored on a non-transitory computer readable medium (e.g., a memory device 205). The software product may comprise data and computer implementable instructions. The instructions, when executed by processing device 210, cause mobile device 130 to perform operations. For example, the mobile device operations may include outputting pre-cached audio content. According to some embodiments, user 135 may have a plurality of mobile devices 130. For example, user 135 may have a mobile device 130 and a connected car. The plurality of mobile devices 130 may work together or separately. For example, audio content may be downloaded using a WiFi connection at the workplace of user 135, but when user 135 gets to his car the downloaded audio content is transmitted using a Bluetooth connection to the memory of the car, which may have more space than the user's mobile device.

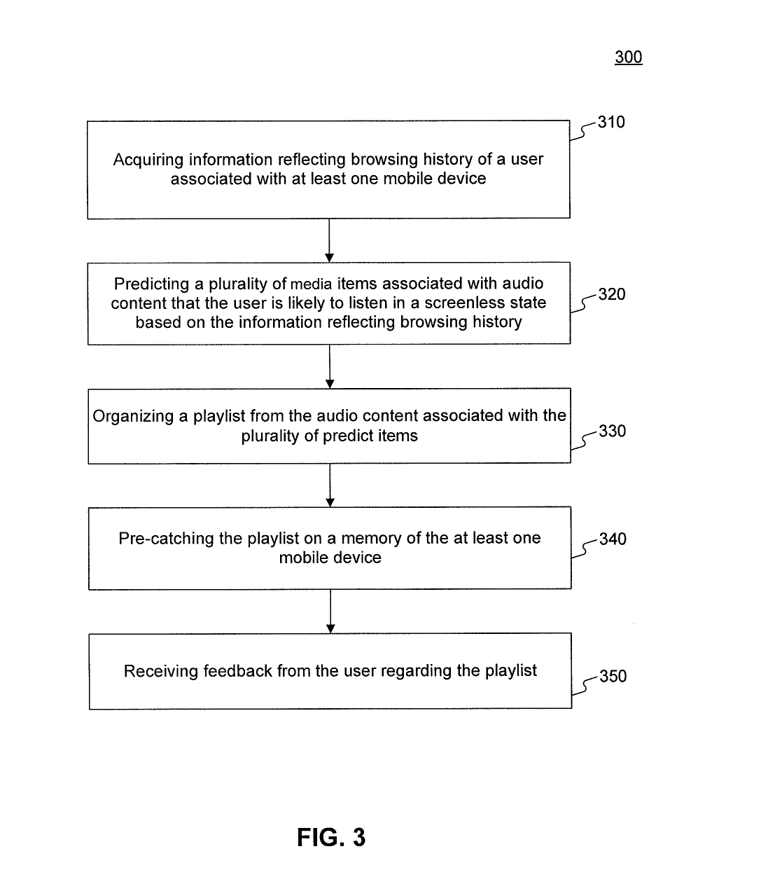

FIG. 3 is a flow chart illustrating an exemplary process 300 for managing pre-cached audio content. Process 300, completely or specific steps, may be carried out by server 100 or by mobile device 130. At step 310, server 100 or mobile device 130 may acquire information reflecting browsing history of a user associated with at least one mobile device. The information reflecting browsing history may include details about previous interests of user 135 in various websites. For example, the browsing history may include a list of websites that user 135 has visited (e.g., The New York Times, BBC News, Ynet), specific content in these websites that user 135 has consumed (e.g., an article about China's economy), or particular content that user 135 has indicated as interesting (e.g., content that user 135 “liked” in social networks). In certain embodiments, the information reflecting browsing history is associated with at least one textual item. For example, the browsing history may include descriptive information (e.g., tags, author, date of creation, subject, sub-subject, size) of textual content that user 135 read. When step 310 is carried out by server 100, acquiring the information reflecting browsing history may include aggregating and integrating information from several devices (mobile or not mobile) associated with user 135.

At step 320, server 100 or mobile device 130 may predict a plurality of media items associated with audio content that user 135 is likely to listen in a screenless state. In some embodiments, the plurality of predicted media items includes a plurality of textual items and the associated audio content includes narrated versions of the plurality of textual items. For example, the audio content may include an audible presentation of a summary of a textual item. In other embodiments, the plurality of predicted media items includes a plurality of video items and the associated audio content includes a soundtrack of the video items.

The term “screenless state” generally refers to a situation in which user 135 engages in an activity (e.g., driving, and jogging) and display 225 is not readily available, or when display 225 is set not to display visual presentation related to the plurality of predicted media items. For example, in the screenless state display 225 may not be accessible for content search and identification. In some cases, the screenless state may include a state where display 225 is turned off or locked and select operations of mobile device 130 may be inaccessible without turning on or unlocking display 225. For example, it may be desirable to set display 225 in an off state for safety reasons when user 135 is driving. In other cases, the screenless state may include a state where display 225 is set to display visual presentation related to a location of user 135. In some embodiments, in a screenless state display 225 may present visual information, but not information directly associated with the predicted media items. In other embodiments, in the screenless state display 225 may present a control center or control commands for quick access to commonly used settings and applications (for example, airplane mode, night mode, mute, pause music), but not present a list of the predicted media items to enable a selection of content.

In some embodiments, server 100 or mobile device 130 may predict the plurality of media items based on the information reflecting browsing history. The process of predicting media items may include determining a user profile based on the browsing history. The profile of user 135 may include parameters indicative of the user's interest in different fields. In a very simplified example, user 135 may browse 30% of the time through the news section of a website, 50% of the time through the entertainment section of the website and 20% of the time through the sports section of the website. Assuming a usage vector U includes only five content sections (News, Sports, Business, Health, and Entertainment), then the usage vector for user 135 may be U=(0.3, 0.2, 0, 0, 0.5). The usage vector U, associated with the user's profile, may be used in predicting media items for user 135. In order to track changes in the usage vector over time, the following expression may be used:

U(t)=α·U(t)+(1−α)·U(t−1)

### Where:

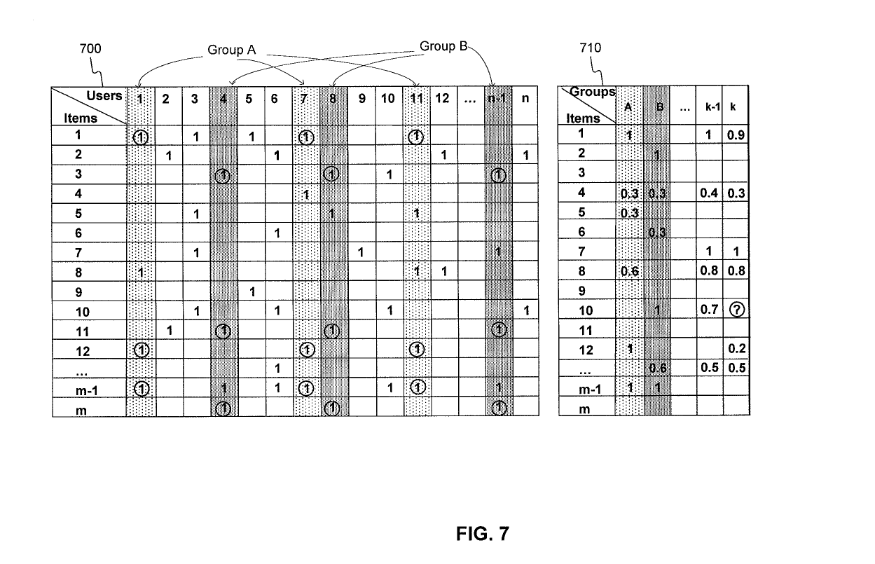

U(t)=Usage vector at time period t;
U(t−1)=the value of U at period t−1; and
α=decay factor.
   Accordingly, a user's playlist may be automatically updated and organized from time to time, as needed. In addition, server 100 or mobile device 130 may use the information reflecting browsing history to identify at least one focus of interest of user 135, and predict additional media items based on the at least one focus of interest of user 135. In some embodiments, the plurality of media items may be predicted using information from a plurality of users 135. In accordance with this embodiment, server 100 or mobile device 130 may identify a plurality of groups of users, wherein each group of users is associated with a group profile, and for each group of users, predict a plurality of media items based on the group profile. A detailed explanation of predicting a plurality of media items associated with audio content using information from a plurality of users 135 is provided below with reference to FIG. 7.

At step 330, server 100 or mobile device 130 may organize a playlist from the audio content associated with the plurality of predicted media items. In one embodiment, the audio content is organized in the playlist in a way that enables user 135 to get his favorite content without an elaborated search. For example, server 100 or mobile device 130 may use the information reflecting browsing history to identify at least two focuses of interest of user 135, and organize the playlist accordingly. In addition, the order in which user 135 reads content in a website may also be taken into consideration in organizing playlist content. For example, assuming user 135 tends to read the sports section after reading the entertainment section, then the playlist may be organized in a similar fashion. For example, audio content associated with media items that relates to sports may be located in the playlist after audio content associated with media items that relates to entertainment. In a different embodiment, the playlist may be organized based on type, size, subject, content, download time, or any other criteria. In addition, the playlist may shuffle the audio content to have a random order. In some embodiments, the profile of user 135 may be used in organizing the playlist.

At step 340, server 100 or mobile device 130 may pre-cache the playlist in a memory of mobile device 130. The expression “pre-cache the playlist” means enabling storage of data associated with the playlist in a memory 205, before user 135 is expected to play the audio content in the playlist. The stored data may include one or more of the following: audio files, metadata files, text files (e.g., files that can be narrated at mobile device 130, and list of identifiers (e.g., Uniform Resource Identifiers for audio content that can be retrieved by the mobile device). In order to store the data before user 135 is expected to play the audio content, server 100 or mobile device 130 may predict when the screenless state is going to start. In one embodiment, server 100 or mobile device 130 may determine at least one scheduling parameter for delivering the playlist to user 135, such that delivery of the playlist to user 135 will be completed before the screenless state starts. The at least one scheduling parameter may take into consideration the memory status of memory device 205, a data plan of mobile device 130, and the bandwidth capacity of a service provider associated with mobile device 130. When step 340 is carried out by mobile device 130, the data associated with the playlist may be actually stored in memory device 205. When step 340 is carried out by server 100 the data associated with the playlist may be transmitted to mobile device 130, before the screenless state is going to start.

At step 350, server 100 or mobile device 130 may receive input from user 135 regarding the playlist. In one embodiment, the input may include management and control commands, for example, next, back, pause, play, stop, and play later. The input in this embodiment may be used by mobile device 130 to navigate the audio content in the playlist. In another embodiment, the input may include information about the preferences of user 135, such as, specific audio content that user 135 liked, or specific audio content that user 135 skipped. For example, user 135 may say “I like this” during a playback, device 130 may record this feedback, and this feedback is later used to revise user's playlist recommendations. The input in this embodiment may be used by server 100 to better predict more media items. Consistent with embodiments of the present invention, the input from user 135 may be communicated using an eyes-free device associated with mobile device 130. An eyes-free device may take the form of any device, component of a device, or a combination of components that enables mobile device 130 to determine the input from user 135. For example, the eyes-free device may include a camera (e.g., camera 215) that can capture the hands or lips movement of user 135, to determine the input. As another example, the eyes-free device may include a microphone (e.g., microphone 220), to identify voice input from user 135. As seen from the examples above, mobile device 130 itself may function as an eyes-free device when display 225 is not being used for the purpose of receiving input. In some embodiments, the eyes-free device may be wirelessly connected to mobile device 130. For example, the eyes-free device may be a wheel Bluetooth controller or a smart watch.

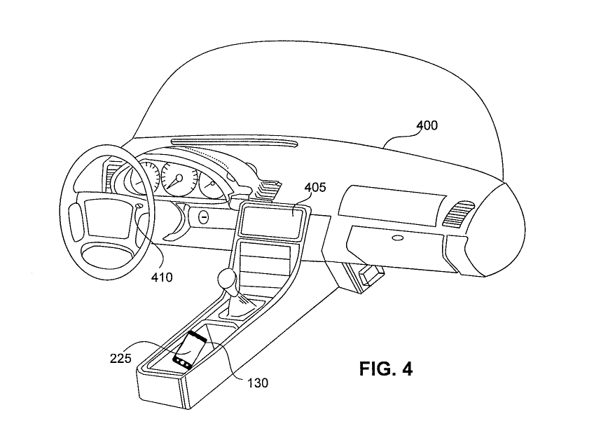

FIG. 4 is a diagrammatic representation illustrating a situation in which systems and methods of this disclosure may be employed. Specifically, FIG. 4 illustrates a situation where user 135 (not shown) may be driving a vehicle 400 and mobile device 130 is in a screenless state. In some embodiments, vehicle 400 may function as mobile device 130. However, in this example, mobile device 130 is the user's smartphone, located in a compartment next to the driver's seat. Mobile device 130 may be paired via Bluetooth with the multimedia system of vehicle 400, such that some information from mobile device 130 may be presented on the vehicle's display 405. In addition, user 135 may control some function of mobile device 130 using steering wheel mounted Bluetooth controls 410. In a typical case, user 135 drives to work every day at 7:00 AM and returns between 5:00 PM to 8:00 PM. According to embodiments of the preset disclosure, server 100 or mobile device 130 may predict a plurality of media items associated with audio content that user 135 is likely to listen while commuting and may pre-cache a playlist of the audio content before the screenless state starts. For example, server 100 may predict between two to fifty (or more) articles that user 135 may be interested in and transmit, using the WiFi connection at the user's home, a narrated version of at least some of the predicted items to mobile device 130 before 7:00 AM.

In some embodiments, an application installed on mobile device 130 may automatically operate in an “audio mode” when the application identifies that user 135 starts to drive. For example, the application may identify that user 135 started to drive by analyzing data from the GPS and other sensors of mobile device 130 Alternatively, the application may notify user 135 about the option to use the “audio mode.” For example, when user 135 launches the application while in vehicle 400, and mobile device 130 is connected via Bluetooth to the vehicle's speakers and playback controllers, an alert window may be opened on display 225 (or display 405) that presents one or more playlists and offer to switch to audio mode. If user 135 selects the “audio mode” option, an audible presentation of the playlist starts and user 135 can control the audible presentation of the playlist using wheel Bluetooth controller 410. In another example, mobile device 130 may be deployed on the windshield to be used as a navigation tool. When the application had been set to work in audio mode it will continue functioning in the background (“behind the navigation application”). User 135 may control the playback using hands' gestures captured by camera 215. In another example, outdoor hiking user 135 can control the audible presentation of the playlist by shaking mobile device.

In other embodiments, an application installed on mobile device 130 may automatically operate in an “audio mode” when the application identifies that there is high likelihood that user 135 wants to listen to audio content, for example, when headphones are plugged. The following disclosure is provided to illustrate an example User Interface (UI) of the application installed on mobile device 130, consistent with embodiments of the present disclosure. Once the “audio mode” is triggered a window opens with the title “Welcome to the Personal Radio by Velocee.” The title and any additional interaction between the application and user 135 may be audible. The UI may request user 135 to approve starting the personal radio. Upon the approval of user 135, the UI may start to play the audio content in the playlist. The playlist may include a “jingle” that keeps playing until other content is played, recent news, narrated shows, podcasts, and more. User 135 can navigate the playlist using simple commands from an eyes-free device, for example, Bluetooth controls 410. The navigation commands may include: stop playback by clicking “pause,” resume playback by clicking “play,” re-listen to current item by clicking “back,” skip current item by clicking “back,” and change playlist by clicking “double skip.” In some embodiments, locations in the playlist may be selected to include ads. The ads can be provided by an ad server or can be played-back from an associated memory. The application installed on mobile device 130 may identify input from user 135 regarding a currently or recently played ad and initiate an action. For example, the application may identify an input from user 135 in response to an ad and initiate a call or provide additional details regarding the ad.

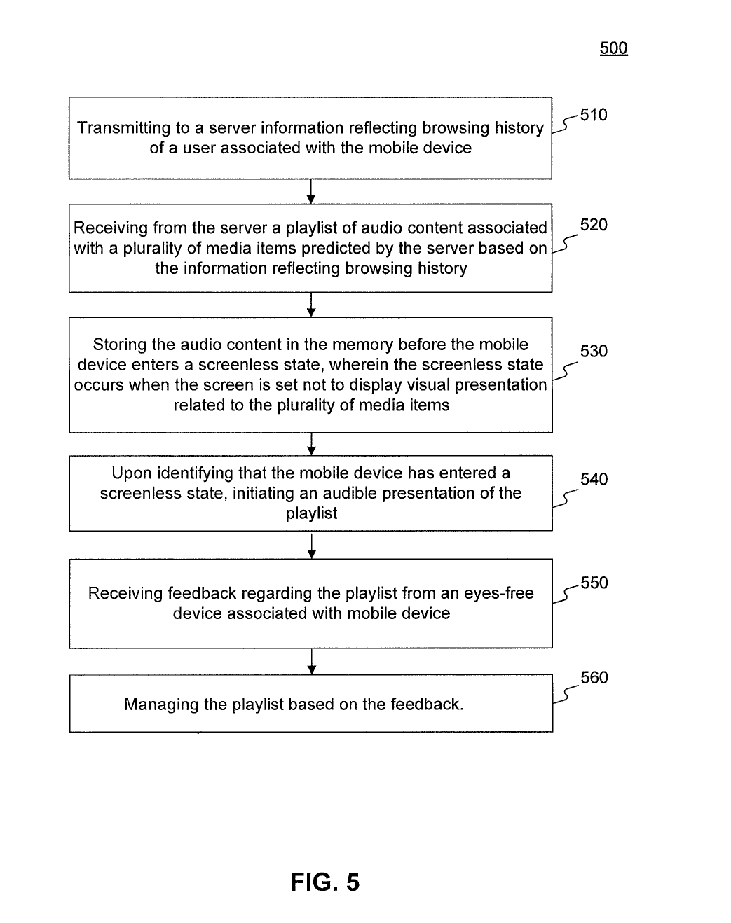

FIG. 5 is a flow chart illustrating an exemplary process 500 being executable by processing device 210 for causing mobile device 130 to perform operations for managing pre-cached audio content. Process 500 may be carried out by mobile device 130 in situations similar to the one illustrated in FIG. 4. At step 510, processing device 210 may transmit to server 100 information reflecting browsing history of user 135. At step 520, processing device 210 may receive from server 100 a playlist of audio content associated with a plurality of media items. The playlist may be received over a wireless connection, for example, the playlist may be received over a WiFi connection more than one to three hours before the audible presentation of the playlist is expected to start. At step 530, processing device 210 may store the audio content in memory device 205 before mobile device 130 enters a screenless state. At step 540, upon identifying that mobile device 130 has entered a screenless state, processing device 210 may initiate an audible presentation of the playlist. At step 550, processing device 210 may receive input regarding the playlist from an eyes-free device associated with mobile device 130. As discussed above, in some embodiments, mobile device 130 may function as an eyes-free device when display 225 is not being used for the purpose of receiving input (e.g., by using camera 215 or microphone 220). In other embodiments, the eyes-free device may be a device separate from but wirelessly connected to mobile device 130. At step 550, processing device 210 may manage the playlist based on the input.

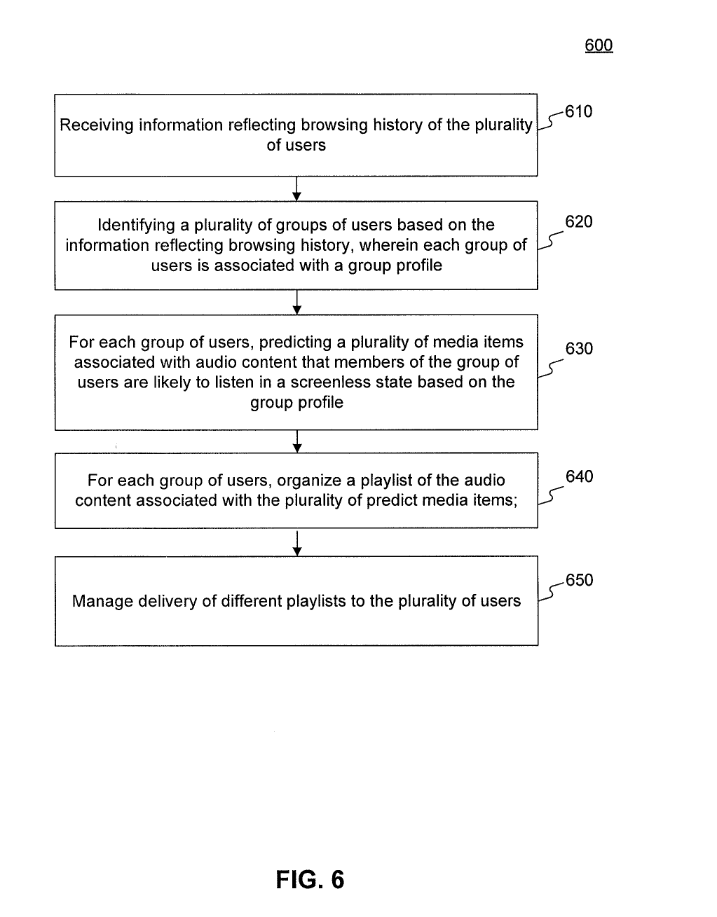

FIG. 6 is a flow chart illustrating an exemplary process 600 being executable by processing device 110 for delivering audio content to mobile device 130. Process 600 may be carried out by server 100 that communicates with a plurality of mobile devices 130 in a configuration similar to the one illustrated in FIG. 1. At step 610 processing device 110 may receive information reflecting browsing history of the plurality of users 135. In some embodiments, server 100 may communicate with mobile device 130 using a cellular network (e.g., cellular network 120) and at least one other wireless network (wireless local area network 125), and the information reflecting browsing history may be received using the at least one other wireless network. For example, the information reflecting browsing history may be transmitted from mobile devices 130 when mobile devices 130 are connected to a WiFi connection and being charged.

At step 620, processing device 110 may identify a plurality of groups of users based on the information reflecting browsing history. Processing device 110 may also determine a group profile for each group of users. The group of users may be identified such that members of each group of users have a similar browsing taste. One way to identify users with similar browsing taste includes determining the usage vector U for each user, and using a “k-means clustering” method. For example, selecting a few K vectors out of the plurality of usage vectors U associated with the plurality of users 135; determining the distance of the usage vectors U from the selected vectors K; using the determined distance to identify groups of users; and calculate an average vector (i.e., the group profile) for each group. This method may be repeated several times to until the average distance of the usage vectors U from the group profile is under a predefined value. Supplemental disclosure and examples of how processing device 110 may identify a plurality of groups of users based on the information reflecting browsing history is provided below with reference to table 700 of FIG. 7.

At step 630 processing device 110 may predict, for each group of users, a plurality of media items associated with audio content that members of the group of users are likely to listen in a screenless state. The predication of the plurality of media items may be based on the group profile. Once the information for the usage vectors U for all the users has been collected and the groups of users have been identified, processing device 110 may predict additional media items for each group of users. In some embodiments, processing device 110 may use collaborative filtering to create a rating matrix. The rating of the media items does not depend on ranking from users 135 (although it may take into consideration). Instead the rating of the media items may be determined based on the popularity of that media item in a specific group of users. For example, a media item may be rated once when at a user in a group consumed this media item (i.e., listen to the associated audio content). The rating may be calculated according to the following expression:

$${Item}_{—} Rating = \frac{{\sum }_{i} {fraction}_{—} {item}_{—} {consumed}_{i}}{{Number}_{—} {users}_{—} {in}_{—} group}$$

### Where:

i=user index in a group; and
Fraction of item consumed=the percentage of audio content associated with media item that have been played back.
   Consistent with embodiments of the present disclosure, processing device 110 may use the rating matrix to predict media items by determining similarity values between pairs of users in a group or between pairs of group profiles. The similarity values may be determined by comparing the ratings values of media items. Supplemental disclosure and examples of how processing device 110 may predict additional media is provided below with reference to table 710 of FIG. 7.

At step 640 processing device 110 may organize, for each group of users, a playlist from the audio content associated with the plurality of predicted media items. The order in which the audio content may be organized in the playlist enables user 135 to get his favorite content without an elaborated search. In some embodiments, processing device 110 may organize multiple playlists for each user 135 or for each group of users. Each playlist may include audio content that users are likely to listen while engaging a different activity associated with the screenless state. For example, processing device 110 may organize a playlist with audio content that user 135 is likely to listen while jogging, and a playlist with audio content that user 135 is likely to listen while commuting. In other embodiments, processing device 110 may organize a playlist such that it would include audio content associated with at least one media item without any previous rating.

At step 650, processing device 110 may manage the delivery of different playlists to users 135. In some embodiments, processing device 110 determines at least one scheduling parameter for delivering the playlists to the plurality of users, such that the delivery of a playlist to user 135 will be completed before the screenless state starts. The scheduling parameter may be a parameter indicative of the time, rate, or quality at which the audio content is delivered. Processing device 110 may deliver one or more playlists to user 135 using only wireless local area network 125. Alternatively, processing device 110 may deliver at least part of the playlists using cellular network 120. The determination regarding which wireless network to use may be based on at least one of the amount of time before the screenless state is expected to start, the memory status of mobile device 130, the data plan of mobile device 130, the cost of delivery and the bandwidth capacity of a service provider associated with mobile device 130.

FIG. 7 includes table 700 illustrating an example of a usage matrix for media item consumption of a plurality of users. In this example, text browsing history is used to select what media content to present in audio. Each column represents a single user 135 (from 1 to n) and each row in table 700 represents a single media item (from 1 to m). The numbers in some of cells associate with the percentage of media content being consumed, for example, a value of 0.5 would indicate that 50% of the media content was consumed. For the purpose of this example, all the values are 1 which means that 100% of the media content was consumed. For example, assuming the media items are articles, user 1 read articles 1, 8, 12 and m−1. As seen from table 700, users 1, 7, and 11 have a similar browsing taste because all of them read articles 1, 12, and m−1. Similarly, users 4, 8, and n−1 have a similar browsing taste because all of them read articles 4, 11, and m. In accordance with one embodiment, users' groups may be determined using K-means clustering algorithm. In the simplified example of FIG. 7, users that have consumed 75% or more of the same media items may be identified as members of a same group. In the example depicted in FIG. 7, users 1, 7, and 11 may be identified as members of group A and users 4, 8, and n−1 may be identified members of group B.

FIG. 7 further includes table 710 illustrating an example of rating matrix of the plurality of identified groups. In this example, each column represents a group or a group profile and each row in table 700 represents single media item (from 1 to m). The value in each cell may be calculated according to the expression above for item rating. The group profile may be used for predicting media items that members of the group of users may be interested in. For example, when comparing user 8 with group profile B it is quite clear that user 8 may be interested in article m−1.

Although the rating matrix includes substantially more data than the usage matrix, still some of the cells remained empty. These cells were left empty because the members of the groups may not have a chance to read these articles or to listen to audio content associated with these articles. According to one embodiment, processing device 110 may estimate the rating of a media item that was not consumed by any member of a group of users. For example, processing device 110 may estimate the rating that group k would give item 10 (marked by a question mark). To do so, processing device 110 may identify a group that have similar rating for other media items. In this case, group k−1 has similar rating for several media items as group k. Therefore, processing device 110 may determine the rating of item 10 for group k based on the rating of item 10 for group k−1.

In one embodiment, processing device 110 may estimate the rating for items of missing ratings in the rating matrix. First, processing device 110 may calculate the similarity between two items, using the following expression:

$$sim ( i , j ) = \frac{{Σ}_{u ∈ U} ( {R}_{u , i} - {\overline{R}}_{u} ) ( {R}_{u , j} - {\overline{R}}_{u} )}{\sqrt{{Σ}_{u ∈ U} {( {R}_{u , i} - {\overline{R}}_{u} )}^{2}} \sqrt{{Σ}_{u ∈ U} {( {R}_{u , j} - {\overline{R}}_{u} )}^{2}}}$$

### Where:

sim(i,j)=similarity between item i and item j;
R_{u,i}=rating of item i by user-group u;
R_{u,j}=rating of item j by user-group u; and
Rᵤ=the average of all user u ratings.
   Second, processing device 110 may determine the missing ratings in the rating matrix, using the following expression:

$${P}_{u , i} = \frac{{Σ}_{{all}_{—} {similar}_{—} items , N} ( {s}_{i , N} * {R}_{u , N} )}{{Σ}_{{all}_{—} {similar}_{—} items , N} ( \vert {s}_{i , N} \vert )}$$

### Where:

P_{u,i}=predicted rating of item i by user u;
s_{i,N}=similarity of item i to item N;
R_{u,N}=rating of N by user-group u; and
N=index of items used to calculate rating prediction of item i by user u.

The foregoing description has been presented for purposes of illustration. It is not exhaustive and is not limited to the precise forms or embodiments disclosed. Modifications and adaptations will be apparent to those skilled in the art from consideration of the specification and practice of the disclosed embodiments. Additionally, although aspects of the disclosed embodiments are described as being stored in memory, one skilled in the art will appreciate that these aspects can also be stored on other types of computer readable media, such as secondary storage devices, for example, hard disks or CD ROM, or other forms of RAM or ROM, USB media, DVD, Blu-ray, or other optical drive media. Computer programs based on the written description and disclosed methods are within the skill of an experienced developer. The various programs or program modules can be created using any of the techniques known to one skilled in the art or can be designed in connection with existing software. For example, program sections or program modules can be designed in or by means of Net Framework, Net Compact Framework (and related languages, such as Visual Basic, C, etc.), Java, C++, Objective-C, HTML, HTML/AJAX combinations, XML, or HTML with included Java applets.

Moreover, while illustrative embodiments have been described herein, the scope of any and all embodiments having equivalent elements, modifications, omissions, combinations (e.g., of aspects across various embodiments), adaptations and/or alterations as would be appreciated by those skilled in the art based on the present disclosure. The limitations in the claims are to be interpreted broadly based on the language employed in the claims and not limited to examples described in the present specification or during the prosecution of the application. The examples are to be construed as non-exclusive. Furthermore, the steps of the disclosed methods may be modified in any manner, including by reordering steps and/or inserting or deleting steps. It is intended, therefore, that the specification and examples be considered as illustrative only, with a true scope and spirit being indicated by the following claims and their full scope of equivalents.

What is claimed is:

1. A method for managing pre-cached audio content, the method comprising:
acquiring information reflecting browsing history of a user associated with at least one mobile device;
predicting a plurality of media items associated with audio content that the user is likely to listen in a screenless state based on the information reflecting browsing history, wherein the screenless state occurs when a display of the at least one mobile device is set not to display visual presentation related to the plurality of media items;
organizing a playlist from the audio content associated with the plurality of predicted media items;
pre-caching the playlist in a memory device of the at least one mobile device; and
receiving input from the user regarding the playlist, wherein the input is communicated using an eyes-free device associated with the at least one mobile device.

2. The method of claim 1, further comprising:
using the information reflecting browsing history to identify at least one focus of interest of the user, and;
predicting additional media items based on the at least one focus of interest of the user.

3. The method of claim 1, wherein the information reflecting browsing history is associated with at least one textual item that the user read.

4. The method of claim 1, wherein the plurality of predicted media items include a plurality of textual items and the audio content includes narrated versions of the plurality of textual items.

5. The method of claim 1, wherein the at least one screenless state includes a state where the screen is turned off.

6. The method of claim 1, wherein the at least one screenless state includes a state where the screen is set to display visual presentation related to a location of the user.

7. The method of claim 1, further comprising:
identifying a plurality of groups of users, wherein each group of users is associated with a group profile; and
predicting, for each group of users, a plurality of media items associated with audio content that members of the group of users are likely to listen in a screenless state based on the group profile.

8. The method of claim 1, further comprising:
predicting when the screenless state is going to start.

9. The method of claim 1, further comprising:
determining at least one scheduling parameter for delivering the playlist to the user, such that delivery of the playlist to the user will be completed before the screenless state starts.

10. A server for delivering audio content, the server comprising:
a memory device configured to store information regarding a plurality of users, each user is associated with at least one mobile device;
at least one processing device configured to:
receive information reflecting browsing history of the plurality of users;
identify a plurality of groups of users based on the information reflecting browsing history, wherein each group of users is associated with a group profile;
predict, for each group of users, a plurality of media items associated with audio content that members of the group of users are likely to listen in a screenless state based on the group profile, wherein the screenless state occurs when a display of the mobile device is set not to display visual presentation related to the plurality of media items;
organize, for each group of users, a playlist from the audio content associated with the plurality of predicted media items; and
manage delivery of different playlists to the plurality of users.

11. The server of claim 10, wherein the at least one processing device is further configured to determine at least one scheduling parameter for delivering a playlist to a user, such that delivery of the playlist to the user will be completed before the screenless state starts.

12. The server of claim 10, wherein the at least one processing device is further configured to communicate with the at least one mobile device using a cellular network and at least one other wireless network, and the different playlists are delivered using the at least one other wireless network.

13. The server of claim 10, wherein the at least one processing device is further configured to organize a plurality of playlists to a user, each playlist includes audio content that the user is likely to listen while engaging a different activity associated with the screenless state.

14. The server of claim 10, wherein the at least one processing device is further configured to manage the delivery of a playlist to a user based on at least one of a memory status of the at least one mobile device, a data plan of the at least one mobile device, and bandwidth capacity of a service provider associated with the at least one mobile device.

15. A non-transitory computer-readable medium having executable instructions stored thereon for a mobile device having at least one processing device, a memory device and a display, the instructions, when executed by the at least one processing device, cause the mobile device to complete a method for managing pre-cached audio content, the method comprising:
transmitting to a server information reflecting browsing history of a user associated with the mobile device;
receiving from the server a playlist of audio content associated with a plurality of media items predicted by the server based on the information reflecting browsing history;
storing the audio content in the memory device before the mobile device enters a screenless state, wherein the screenless state occurs when the screen is set not to display visual presentation related to the plurality of media items;
upon identifying that the mobile device has entered a screenless state, initiating an audible presentation of the playlist;
receiving input regarding the playlist from an eyes-free device associated with the mobile device; and
managing the playlist based on the input.

16. The non-transitory computer-readable medium of claim 15, wherein the input includes at least one of the following commands: next, previous, pause, play, stop, and play later.

17. The non-transitory computer-readable medium of claim 15, wherein the eyes-free device includes a microphone.

18. The non-transitory computer-readable medium of claim 15, wherein the eyes-free device includes a camera.

19. The non-transitory computer-readable medium of claim 15, wherein the eyes-free device is wirelessly connected to the mobile device.

20. The non-transitory computer-readable medium of claim 15, wherein the playlist is received over a WiFi connection more than hour before the audible presentation of the playlist is expected to start.
